(19) United States
(12) Patent Application Publication
(10) Pub. No.: US 2007/0242998 A1
(43) Pub. Date: Oct. 18, 2007

(54) Method and apparatus for image forming

(75) Inventors: Hisaya Ishio, Toda-shi (JP); Hitoshi Kato, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/406,161

(22) Filed: Apr. 18, 2006

(51) Int. Cl. G03G 15/00

(52) U.S. Cl. 399/405

(57) ABSTRACT

In an embodiment of an image forming apparatus of the invention, a sheet medium holding device has a specified area, and includes a first and a second trays to hold a sheet medium, and the first and the second trays are positioned within a range of an installation area of a housing and the area of the sheet medium holding device, and accordingly, the first and the second trays can be switched based on the kind of image data from which an image forming unit forms a developer image.

### BACKGROUND OF THE INVENTION

1. Field of the Invention

The present invention relates to an image forming apparatus that reduces a space for holding a sheet-like medium on which an image or a document is outputted and can prevent an outsider from taking away the outputted image or document.

2. Description of the Related Art

In an image forming apparatus such as a color copier or a printer, there is provided a paper output tray for temporarily holding a sheet-like medium on which an image or a document has been outputted until a user takes back it.

In many image forming apparatuses, a paper output tray is provided in a space projecting toward the outside from the range (installation area) in which the image forming apparatus is installed. This means that the space larger than the installation area of the image forming apparatus is required as the space for operating the image forming apparatus. Incidentally, in a case where there is also provided, for example, a finisher device for stapling an arbitrary number of sheet media on which images or documents have been outputted, the position of the paper output tray can be “separate position” where the user working in the vicinity of the image forming apparatus is requested to be moved in the case where the sheet media are brought back (taken out).

On the other hand, an image forming apparatus has also been put to practical use in which a paper output tray is used also as a part of the exterior of the image forming apparatus and is arranged at a specified position in the height direction of the image forming apparatus. Nevertheless, a scanner device to scan an image or a document outputted from the image forming apparatus is generally positioned above the paper output position where a sheet medium is held. Thus, the ejected sheet medium is hard to see, which becomes a factor to cause forgetfulness to take out (the medium). This increases a fear that the output medium forgotten to take out (take back) falls to an outsider.

### BRIEF SUMMARY OF THE INVENTION

An object of the invention is to provide an image forming apparatus that reduces a space for holding an outputted sheet-like medium and can prevent an outsider from taking away the sheet-like medium as an outputted image or document.

According to the invention, there is provided an image forming apparatus comprising:

a read object transport device that includes an image sensor to convert image information of a read object having the image information into image data, the image sensor being positioned at a read position to which the read object is guided, and that can be opened to a specified angle in a direction unparallel to the read position;

an image forming mechanism that forms a developer image corresponding to the image data;

a fixing device that fixes the developer image on a sheet medium;

a first sheet medium holding mechanism that has a specified area, holds the sheet medium, on which the developer image has been fixed, within a range of an area defined by the image forming mechanism and the specified area, and is positioned above the first sheet medium holding mechanism with an interval to prevent contact with the read object at a time point when the read object transport device has been opened to the specified angle; and

a second sheet medium holding mechanism that holds the sheet medium, on which the developer image has been fixed, within the range of the area defined by the image forming mechanism and the specified area of the first sheet medium holding mechanism, is positioned above the first sheet medium holding mechanism, and has a periphery covered with a cover mechanism.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view for explaining an example of an image forming apparatus to which an embodiment of the invention is applied;

FIG. 2 is a schematic view showing a transport passage of a sheet medium in the image forming apparatus shown in FIG. 1; and

FIG. 3 is a schematic block diagram for explaining the flow of an image signal and a signal for control in the image forming apparatus shown in FIGS. 1 and 2.

### DETAILED DESCRIPTION OF THE INVENTION

Hereinafter, an embodiment of the invention will be described with reference to the drawings.

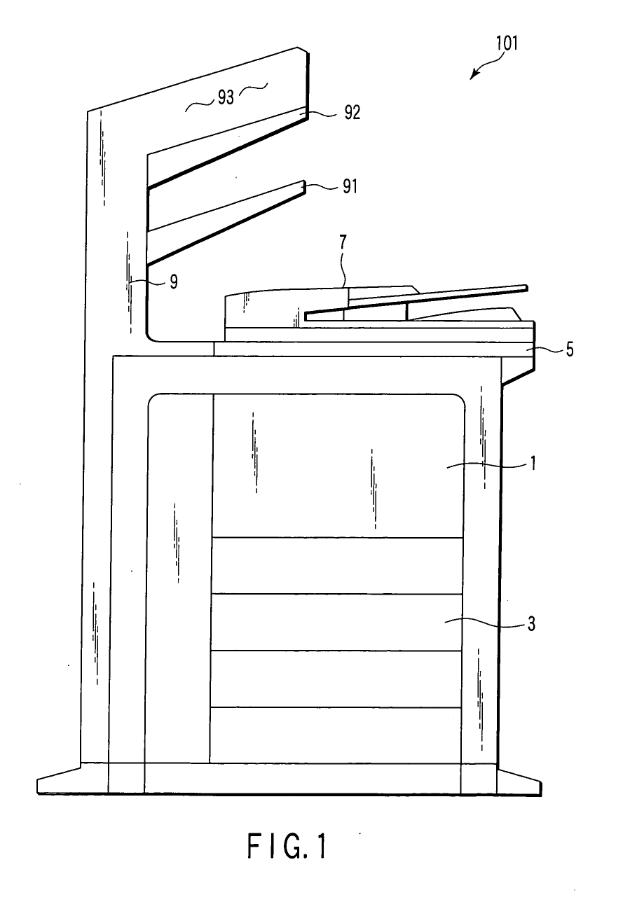

FIG. 1 shows an example of an image forming apparatus to which the embodiment of the invention is applied.

An image forming apparatus 101 shown in FIG. 1 includes an image forming part (engine) 1 to output image information, such as a character, a photograph or graphics, as an image output called, for example, a hard copy or a printout, a sheet supply part 3 capable of supplying a sheet-like medium (hereinafter referred to as a sheet) with an arbitrary size used for image output to the image forming part 1, and an image read part (scanner) 5 to capture image information, which is an object of image formation in the image forming part 1, as image data from an objective material (hereinafter referred to as a document) holding the image information. Although not described in detail, the image read part 5 includes a document table to support the objective material and an image sensor to convert the image information into the image data, for example, a CCD sensor. In the image read part 5, illumination light from a not-shown illumination device is irradiated to the document set on the document table, so that reflected light from the document, which includes the image information of the document as the variations of light and shade, is transmitted to the CCD sensor.

Incidentally, the image read part 5 is integrally provided with an auto document feeder (ADF) 7 in which in a case where sheet-like documents are used, after the formation of image output or the capture of image information (hereinafter referred to as reading) is ended, the document whose reading has been ended is sent to a specified position, and a next document is guided to the reading position. Of course, it is needless to say that instead of the ADF 7, a general document cover (document holding member) may be used.

When the CCD sensor of the image read part 5 is provided independently of the document table and at an arbitrary position in a transport passage through which the document is transported, the image information of the document during the transport can be read as the image data without positioning the document on the document table.

At a position in the vicinity of the image read part 5 and the ADF 7 and above the ADF 7, a paper output unit 9 is provided that holds a sheet, on which an image output, that is, an image formed by the image forming part 1 has been transferred and fixed, until the user takes out (takes back). Incidentally, it is needless to say that the paper output unit 9 is positioned at a position where it does not come in contact with the ADF 7 when the ADF 7 is opened up to a specified angle with respect to the document table of the image read part 5.

Incidentally, the image forming apparatus 101 has an installation area in which the paper output unit 9 is connected in the state where the image forming part 1, the sheet supply part 3 and the image read part 5 are stacked. By this structure, areas obtained when a first and a second paper output trays 91 and 92 of the paper output unit 9 are projected in a plane direction are smaller than the image forming part 1 (image read part 5).

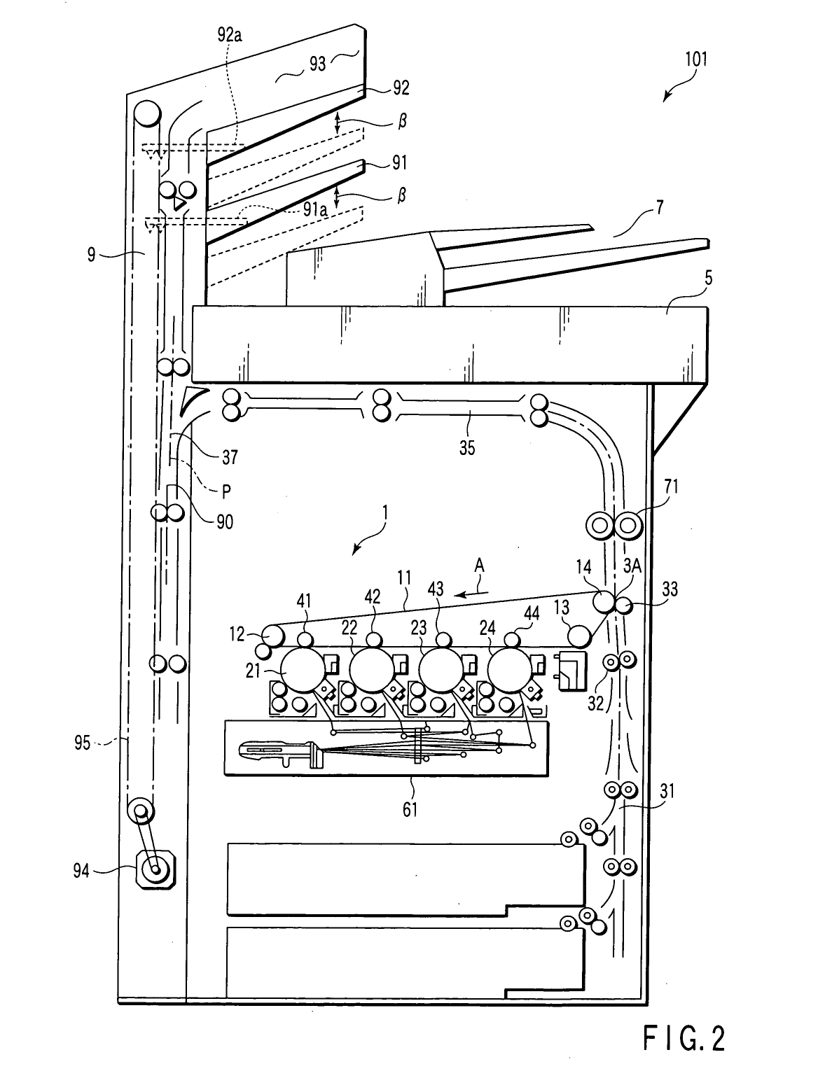

As shown schematically in FIG. 2, the image forming part 1 includes an intermediate transfer belt 11 in which, for example, an insulating film with a specified thickness is formed into a belt shape. Incidentally, the intermediate transfer belt 11 in which a metal is formed into a thin sheet shape and its surface is protected with a resin or the like can also be used.

The intermediate transfer belt 11 is given a specified tensile force by a drive roller 12, a first tension roller 13, and a second tension roller 14, and an arbitrary position parallel to an axial line of the drive roller 12 is moved in an arrow A direction by the rotation of the drive roller 12. That is, the belt surface of the intermediate transfer belt 11 is circulated at a speed at which the outer peripheral surface of the drive roller 12 is moved and in one direction indicated by the arrow A.

A first to a fourth image forming units 21 to 24 are arranged at specified intervals in a section in which the belt surface of the intermediate transfer belt 11 is moved substantially in a plane shape. Incidentally, in the example shown in FIG. 2, in the section where the intermediate transfer belt 11 is moved substantially in the plane shape between the drive roller 12 and the first tension roller 13, the first image forming unit 21 is positioned at the drive roller 12 side, and the fourth image forming unit 24 is positioned at the first tension roller 13 side.

Each of the first to the fourth image forming units 21 to 24 includes at least a developing device containing toner of an arbitrary color of Y (yellow), M (magenta), C (cyan) and Bk (black), and a photoconductor drum to hold an electrostatic image to be developed by the developing device. An electrostatic image of a color to be developed by the developing device in the image forming unit is formed on the photoconductor of each of the image forming units by image light from an exposure device 61, and is developed by selective supply of toner from the corresponding developing device. Incidentally, in each of the image forming units 21 to 24, the photoconductor drum not described in detail is charged to a specified potential by one of a non-contact (corona discharge or the like) method and a contact (by charged roller or the like) method.

Transfer rollers 41 to 44 to transfer toner images as developer images, which are obtained such that the electrostatic images on the photoconductor drums of the respective image forming units are developed by the developing devices, to the intermediate transfer belt 11 are provided at the back side of the intermediate transfer belt 11 in a state where the intermediate transfer belt 11 is interposed between the first to the fourth image forming units 21 to 24 and the transfer rollers.

In the respective image forming units 21 to 24, the electrostatic images are formed at specified timings so that the toner images successively transferred on the intermediate transfer belt 11 are overlapped with each other on the intermediate transfer belt 11, and are developed by the corresponding developing devices.

The toner images overlapped on the intermediate transfer belt 11 are transferred to a sheet P, which is supplied from an arbitrary cassette of the sheet supply part 3 and is guided to a transfer position 3A through a transport passage 31, by a transfer roller 33 which is brought into contact with the intermediate transfer belt 11 at a specified pressure. Incidentally, the positional relation between the sheet P guided to the transfer position 3A and the toner images transported on the intermediate transfer belt 11 is controlled by a register roller 32.

The sheet P on which the toner images have been transferred by the transfer roller 33 is continuously transported through the transport passage 31, and the toner images are fixed in a fixing device 71.

The sheet P on which the toner images have been fixed is guided through a discharge transport passage 35, and is guided to the paper output unit 9, while a state where the surface on which the toner images are fixed is directed toward the image forming part 1 side is kept by a front-back inverting mechanism 37 not described in detail.

The paper output unit 9 includes the first paper output tray 91 and the second paper output tray 92. Incidentally, the respective paper output trays 91 and 92 are stacked (laminated) in the vertical direction so as to fall within the range of the installation area in a state where the image forming apparatus 101 is seen from above, that is, in a state where the image forming apparatus 101 is projected onto a plane. Besides, the first and the second paper output trays 91 and 92 and the front-back inverting mechanism 37 are connected to each other through a paper output part transport passage 90.

The first paper output tray 91 is mainly used to hold a hard copy (duplication) obtained by copying an image of a document by the image forming apparatus 101.

The second paper output tray 92 is mainly used to hold an image output (printout) printed out by the image forming apparatus 101. Incidentally, a security BOX 93 covering the periphery of the tray 92 and capable of preventing an outsider from taking away the printout is provided integrally with the second paper output tray 92.

The first paper output tray 91 is lowered to a previously determined takeout position at a time point when the hard copy (image output) by the image forming apparatus 101 is ended and a lowering instruction by the user is inputted.

The second paper output tray 92 keeps the state in which the printout is contained in the security BOX 93 at the time point when the printout by the image forming apparatus 101 is ended. That is, the second paper output tray 92 can prevent the printout from being seen by an outsider. Incidentally, for example, an identification number is inputted from an operation panel (not described in detail) by a user (sender of a print cue) having requested the printout, or identification using an ID card or the like, or identification by Radio Frequency Identification (RFID, that is, contrivance to identify/manage a person and a thing by a micro radio chip) is ended, the second paper output tray 92, together with the first paper output tray 91, is lowered to the previously determined takeout position. At this time, the security BOX 93 is not moved. Accordingly, a space (opening) necessary for the user to take out the sheet (medium) is ensured between the second paper output tray 92 and the security BOX 93. Incidentally, when the second paper output tray 92 is moved (lowered), the first paper output tray 91 is also lowered at the same time, and accordingly, in the case where the hard copy has been outputted on the first paper output tray 91, it is possible to prevent the interference between the hard copy and the second paper output tray 92.

Incidentally, the first and the second paper output trays 91 and 92 can be moved in an arrow B direction at the foregoing specified timings by stays 91a and 92a fixed to a thrust transmission mechanism 95, such as a wire or a chain, obtaining the thrust by, for example, a motor 94.

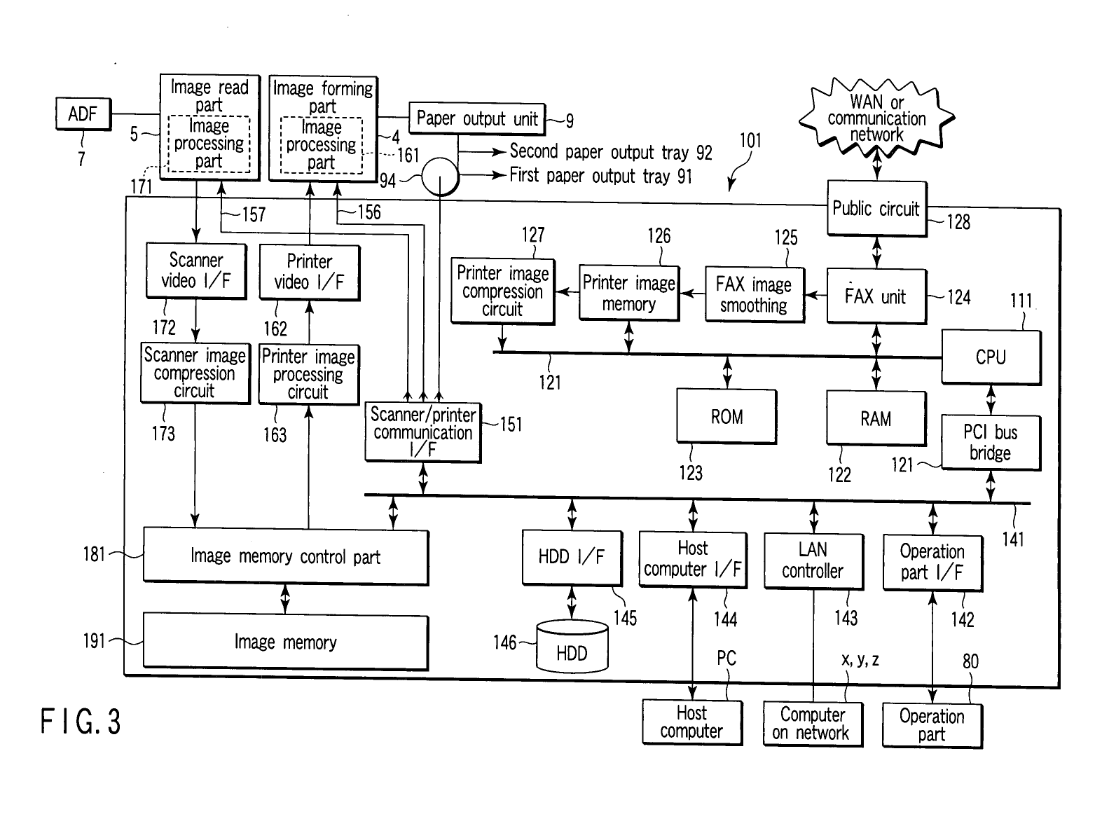

FIG. 3 schematically shows a control block used for the control of the image forming apparatus 101 shown in FIG. 1 and FIG. 2.

As shown in FIG. 3, the image forming apparatus 101 includes a main control block (CPU) 111, a CPU local bus 121 connected to the CPU 111, a PCI bus bridge 131 connected to the CPU 111, and a PCI bus 141 connected to the PCI bus bridge 131.

The CPU local bus 121 is connected with, for example, a RAM 122 and a ROM 123. The RAM 122 is used as a program memory used for the CPU 111 to perform a processing or as a data storage area. The ROM 123 is used as a storage area of a boot program necessary for system startup, a program used for the CPU 111 to realize various functions, and fixed data. The program and data on the ROM 123 may be held as compressed data in the ROM 123 and may be expanded and executed in the RAM 122.

The image forming part (printer part) 1 and the image read part (scanner part) 5 are respectively connected to the PCI bus 141 through a scanner/printer communication interface 151.

An operation part 80 is connected to the PCI bus 141 through an operation part interface 142. Incidentally, the operation part (instruction input/display part) 80 includes, although not described in detail, a touch panel sensor used for an operation (on/off) instruction by a user, mode selection (selection instruction), numerical value input, function selection (selection input) and the like, a graphical display capable of displaying an indication corresponding to the instruction by the touch panel sensor, a response screen corresponding to the selection input and the like, dedicated buttons (input keys) frequently used for input (entry) of numerals, such as the number of copies (printings), start/cancel and the like, a state display LED and the like. Besides, for example, a card reader used for ID identification to open the security BOX 93 is also incorporated.

The PCI bus 141 is connected with an arbitrary computer existing on the network and other MFP (Multi-Functional Peripherals) x, y and z through a LAN (local area network) controller 143.

The PCI bus 141 is also connected with, for example, a host computer PC as an external device through a host computer interface 144. The host computer interface 144 is a well-known interface such as, for example, ethernet®, USB (Universal Serial Bus), IEEE 1284 or IEEE 1394.

Besides, the PCI bus 141 is connected through a HDD (hard disk drive) interface 145 to a HDD (hard disk drive) 148 capable of holding a large capacity of data.

Incidentally, the image forming apparatus 101 can also perform FAX communication through a FAX unit 124 connected to the CPU local bus 121 and using WAN or communication network connectable through a public line 128.

The main control block 111 gives and receives control signals to and from each of the image forming part 1 and the image read part 5 connected through the scanner/printer communication interface 151, controls the operation of the image read part 5 to read color or black-and-white image data, and controls the image formation part 1 to output color or black-and-white image data.

The read image data is once stored in an image memory 191, so that repeated output (output of plural sheets) of an image to obtain a necessary number of sheets, N in 1 output in which images of plural pages are reduced and arranged on one sheet, image rotation to enable arbitrary gathering of document images in units of 90 degrees, form composition to construct a form frame or the like in the read image, composition of date, logo mark (s) and/or water mark(s), and the like can be performed by only one reading of the document image.

The read image data is compressed in an image processing part 171 or an image memory control part 181 by an encoding process as the need arises. By this, the amount of image data held in the HDD 148 can be reduced. Besides, by the compression, more image data can be stored in the HDD 148. Incidentally, image data once stored in the HDD 148 is outputted in an arbitrary order and an arbitrary number of times, so that output (printout) of a requested arbitrary number of sheets (number of copies), called electronic sort, can be performed.

The scanner/printer communication interface 151 exchanges control information, such as a command and a status, with the image forming part (printer) 1 and the image read part (scanner) 5 by a serial communication 157 to the scanner (image read part) 5 and the serial communication 156 to the printer (image forming part) 1. By this, information, such as the start and operation state of the image forming apparatus 101, the acquisition of a read document size and type, the designation of a sheet size, and the remaining amount of toner and sheet, can be notified to the CPU 111.

Besides, the image forming apparatus (MFP) 101 receives image data for image output from peripheral (external) equipments connected through various connections, such as local connection (connection via the host computer interface 144) of IEEE 1284, IEEE 1394 or USB, LAN connection via the LAN controller 143, and connection to the communication network or WAN (Wide area network) via the public line 128 connected to the FAX unit (modem) 124, and can output (print out) it.

The image data read in the image read part 5 is inputted to a scanner image compression circuit 173 via a scanner video interface 172, and after being compressed by the image compression circuit 173, the image data is stored in the image memory 191 through the image memory control part 181.

In a printer image processing circuit 163, conversion is performed into a necessary common image format requested in the image forming part 1, and the image data is outputted to the image forming part 1 via a printer video interface 162. Incidentally, in an image processing part 161 of the image forming part 1, the image data on the image memory 191 is encoded or decoded. In this encoding/decoding, reversible variable length encoding (rule) is used.

The image memory control part 181 controls the large capacity image memory 191 in which code data of non-compressed images and compressed images can be stored, and controls the reading of the image data from the scanner to the image memory and the print output of the image data from the image memory to the printer.

Incidentally, the foregoing image memory control part 181 supports handling of image data of various formats, and can select the optimum compression system according to an employed function correspondingly to a monochrome image or a color image in binary images, or each of monochrome and color image data of the copy function and the network printer function in multi-value images.

For example, when the user requests the printout from the foregoing image forming apparatus 101 by the host computer PC, the control signal is inputted from the host computer PC to the main control block (CPU) 111 via the host computer interface 144.

The image data to be printed out is stored in the image memory 191 via the PCI bus 141 and the image memory control part 181.

The image data stored in the image memory 191 is supplied to the printer image processing circuit 163 at a specified timing (via the image memory control part 181) by the control of the CPU 111.

The image data supplied to the printer image processing circuit 163 is inputted to the image processing part 161 of the image formation part (printer) 1 through the printer video interface 162, and is converted into raster data to be outputted from the exposure device 61.

Subsequently, image light (exposure light) corresponding to the image data is outputted from the exposure device 61 to the photoconductor drums of the image forming units 21 to 24 holding developers (toners) of the corresponding colors.

In each of the image forming units 21 to 24, an electrostatic image (electrostatic latent image) corresponding to the exposure light is formed on the photoconductor drum.

The electrostatic latent image formed on each of the photoconductor drums is developed with the toner of the requested color and is visualized.

The four-color toner images formed by the respective image forming units 21 to 24 are successively transferred by the transfer rollers 41 to 44, and are overlapped with each other on the intermediate transfer belt 11.

The toner images overlapped on the intermediate transfer belt 11, that is, the color image is transferred by the transfer roller 33 to the sheet-like medium, that is, the sheet P transported through the transport passage 31 while the timing is adjusted according to the position of the image on the belt 11.

The color image transferred on the sheet P is fixed on the sheet P in the fixing device 71.

The sheet P on which the toner images have been fixed is transported through the discharge transport passage 35 to the front-back inverting mechanism 37, the state where the surface on which the toner images are fixed is directed toward the image forming part 1 side is kept by the front-back inverting mechanism 37, and it is guided to the paper output unit 9. At this time, in the paper output part transport passage 90 of the paper output unit 9, the passage (transport passage) is defined toward the second paper output tray 92 by the control signal from the CPU 111 through the scanner/printer communication interface 151.

By this, the image output printed out by the print request from the host computer PC is contained in the security BOX 93 (second paper output tray 92).

The second paper output tray 92 keeps the state where printouts are contained in the security BOX 93 after the whole printout by the image forming apparatus 101 is ended and until the open of the security BOX 93 is instructed by, for example, the operation part 80. That is, the second paper output tray 92 can prevent the printout from being seen by an outsider. Incidentally, after the identification number is inputted from, for example, an operation panel (not described in detail) or by the user having requested the printout, or the identification using an ID card or the like is ended, the second paper output tray 92 is lowered to the previously determined takeout position. At this time, the security BOX 93 is not moved. Accordingly, a space (opening) necessary for the user to take out the sheet (the medium) is ensured between the second paper output tray 92 and the security BOX 93.

On the other hand, for example, in the case where the user instructs the image forming apparatus 101 to perform reading of image information from a sheet-like medium, that is, a document by using the image read part 5 (ADF 7) and to perform image formation, that is, copying, the image information of the document is captured as the variations of light and shade by the image read part (scanner) 5. The captured light (the variations of light and shade) is converted into image signals by, for example, a CCD sensor although it is not shown, and a specified correction is performed by the image processing part 171.

The image signal to which the specified correction has been applied by the image processing part 171 is inputted to the scanner image compression circuit 173 via the scanner video interface 172.

The image signal which is the image information of the document and is compressed by the scanner image compression circuit 173 is stored in the image memory 191 via the image memory control part 181.

The image data stored in the image memory 191 is supplied to the printer image processing circuit 163 at a specified timing (via the image memory control part 181) by the control of the CPU 111.

The image data supplied to the printer image processing circuit 163 is inputted to the image processing part 161 of the image forming part (printer) 1 through the printer video interface 162, and is converted into the raster data to be outputted from the exposure device 61.

After this, by a similar process to the already described printout, a toner image corresponding to the image information of the document is formed, and the toner image is transferred at a specified timing to the sheet P transported through the transport passage 31.

The sheet P on which the transferred color image is fixed in the fixing device 71 is transported through the discharge transport passage 35, and is guided to the paper output unit 9, while the state where the surface on which the toner image is fixed is directed toward the image forming part 1 side is kept by the front-back inverting mechanism 37.

At this time, in the paper output part transport passage 90 of the paper output unit 9, the passage (transport passage) is defined toward the first paper output tray 91 by the control signal from the CPU 111 through the scanner/printer communication interface 151.

By this, the hard copy on which the image of the document read by the image read part (scanner) 5 is copied (duplicated) is successively laminated on the first paper output tray 91.

After the whole copy (duplication) by the image forming apparatus 101 is ended, at a specified timing or at a time point when a lowering instruction by the user is inputted, the first paper output tray 91 is lowered to the previously determined takeout position. Accordingly, the user can easily take out (take back) the copy without moving from the vicinity of the main body of the image forming apparatus 101 in order to take out (take back) the copy (hard copy).

As described above, according to the embodiment of the invention, the image forming apparatus is obtained in which the space for holding the outputted sheet-like medium is reduced, and which can prevent the outputted image or document <sheet-like medium> from being taken away by an outside.

Besides, although the paper output tray is provided above the main body of the image forming apparatus, since the tray is lowered to the specified position when the sheet-like medium (sheet) is taken out, forgetfulness to take out the sheet can be prevented.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a read object transport device that includes an image sensor to convert image information of a read object having the image information into image data, the image sensor being positioned at a read position to which the read object is guided, and that can be opened to a specified angle in a direction unparallel to the read position;
an image forming mechanism that forms a developer image corresponding to the image data;
a fixing device that fixes the developer image on a sheet medium;
a first sheet medium holding mechanism that has a specified area, holds the sheet medium, on which the developer image has been fixed, within a range of an area defined by the image forming mechanism and the specified area, and is positioned above the first sheet medium holding mechanism with an interval to prevent contact with the read object at a time point when the read object transport device has been opened to the specified angle; and
a second sheet medium holding mechanism that holds the sheet medium, on which the developer image has been fixed, within the range of the area defined by the image forming mechanism and the specified area of the first sheet medium holding mechanism, is positioned above the first sheet medium holding mechanism, and has a periphery covered with a cover mechanism.

2. The image forming apparatus according to claim 1, wherein the first sheet medium holding mechanism and the second sheet medium holding mechanism are positioned mutually in a stacked state, and their projection areas when viewed from a plane direction are roughly equal to each other.

3. The image forming apparatus according to claim 1, wherein heights of the first sheet medium holding mechanism and the second medium holding mechanism are changed after all sheet media supplied from the fixing device are held and at a time point when lowering is instructed.

4. The image forming apparatus according to claim 3, wherein the height of the second sheet medium holding mechanism is changed at a time point when a specified condition is satisfied.

5. The image forming apparatus according to claim 4, wherein the height of the second sheet medium holding mechanism is changed independently of the cover mechanism.

6. An image forming apparatus comprising:
an image forming unit that forms a developer image corresponding to image data;
a fixing unit that fixes the developer image on a sheet medium;
a housing that contains the image forming unit and the fixing unit and has a specified installation area;
a sheet medium holding device that has a specified area, includes a first and a second trays to hold the sheet medium, and positions the first and the second trays within a range of the specified installation area of the housing and the specified area; and
a tray control device that switches between the first and the second trays based on a kind of the image data from which the image forming unit forms the developer image.

7. The image forming apparatus according to claim 6, further comprising:
a tray cover device that enables takeout <<transfer/movement>> of the sheet medium held by the second tray under a specified condition.

8. The image forming apparatus according to claim 7, wherein the tray cover device enables the takeout <<transfer/movement>> of the sheet medium in a case where the second tray is moved to a specified position.

9. The image forming apparatus according to claim 8, wherein the tray cover device prevents a gap from being produced around the second tray.

10. The image forming apparatus according to claim 6, wherein the specified installation area of the housing includes an area where the sheet medium holding device is installed.

11. The image forming apparatus according to claim 10, wherein areas of the first and the second trays projected in a plane direction fall within the range of the specified installation area of the housing.

12. The image forming apparatus according to claim 11, wherein the first and the second trays are stacked on each other.

13. A sheet transporting method for transporting a sheet medium holding an image visualized by a visualizing agent to one of a first and a second holding mechanisms based on a supply source of image data used for formation of the visualized image, comprising:
transporting the sheet medium to the first holding mechanism in a case where the image data used for the formation of the visualized image is supplied from a supply source provided integrally with a device for forming the visualized image; and
transporting the sheet medium to the second holding mechanism in a case where the image data used for the formation of the visualized image is supplied from a supply source provided at a place different from the device for forming the visualized image.

14. The sheet transporting method according to claim 13, wherein in the second holding mechanism, a gap is prevented from being produced around it.

15. The sheet transporting method according to claim 14, wherein the second holding mechanism is moved to a specified position under a specific condition, and can provide a space for takeout <<movement/transfer>> of the sheet medium.
